(19) United States
(12) Patent Application Publication
(10) Pub. No.: US 2013/0043815 A1
(43) Pub. Date: Feb. 21, 2013

(54) PROTECTION CIRCUIT FOR A D.C. BRUSHLESS MOTOR PUMP

(71) Applicant: Hsia-Yuan HSU, Taichung City (TW)

(72) Inventor: Hsia-Yuan HSU, Taichung City (TW)

(21) Appl. No.: 13/209,594

(22) Filed: Aug. 15, 2011

(51) Int. Cl. H02H 7/093

(52) U.S. Cl. 318/400.21

(57) ABSTRACT

A protection circuit 30 for a D.C. brushless motor pump in the present invention is to be installed on or connected to a driving circuit 40. The driving circuit 40 is installed on a motor 100 of the D.C. brushless motor pump. The motor consists of a rotor set and a stator set, while the protection circuit contains a micro-processing unit, a driving unit, a comparison unit and a signal source. The micro-processing unit is electrically connected with the driving unit, the comparison unit is electrically connected with the micro-processing unit while the signal source is electrically connected with the comparison unit. The signal source is a voltage signal produced by the motor itself when the rotor set is operated. The comparison unit can convert the signal source into a rotating speed value of the rotor set, and the micro-processing unit can function to supervise and control rotating speeds of the motor.

### BACKGROUND OF THE INVENTION

1. Field of the Invention

This invention relates to a protection circuit, particularly to one applied to a D.C. brushless motor pump.

2. Description of the Prior Art

A pump is a mechanical device employed to increase pressure of liquid or gas for facilitating the liquid or the gas to be conveyed. A conventional pump includes a housing, a vane wheel and a motor. The housing is formed with an accommodating chamber in the interior and provided with thereon with a water intake and a water outlet, which communicate with the accommodating chamber. The vane wheel received in the accommodating chamber consists of a wheel body and a plurality of vanes annularly fixed around the circumferential side of the wheel body that has a central portion fixed with a rotating shaft by which the vane wheel can be operated together with the motor. When the pump is operated, liquid will be pumped to get into the accommodating chamber through the water intake, and the vane wheel will start rotating to have the vanes actuating the liquid to flow toward the water outlet. However, during operation of the pump, the liquid conveyed may contain impurities or unknown objects, which will flow into the pump together with the liquid to clog the water intake and make the liquid impossible to smoothly flow into the accommodating chamber. As a result, the pump may run idle to lose its function and the inner mechanism of the motor may be damaged due to excessively high temperature caused by idle running of the pump. Further, for purpose of controlling rotating speeds, the conventional pump has to be additionally installed inside with a water pressure sensor or a water flow sensor for detecting rotating speeds of the motor so as to control the motor to operate within a range of ideal rotating speeds, thus not only increasing manufacturing cost but also spoiling the structural strength of the pump. Furthermore, after used in water for a long period of time, the water pressure sensor is apt to produce aging and even cause trouble to affect operation of the pump.

### SUMMARY OF THE INVENTION

A first objective of this invention is to offer a protection circuit for a D.C. brushless motor pump, able to supervise and control the rotating speeds of the D.C. brushless motor of a pump to enable the motor to operate or stop operating within a range preset for protecting the structure of the D.C. brushless motor pump.

A second objective of this invention is to offer a protection circuit for a D.C. brushless motor pump, able to detect rotating speeds of the motor via a signal source (such as a Hall Effect IC, a counter electromotive force or a coder), which is produced by the motor itself when the rotor set is operated, needless to additionally install other electronic members like a water pressure sensor or a water flow sensor and thus able to reduce manufacturing cost of the D.C. brushless motor pump.

For attaining the purpose above mentioned, the protection circuit for a D.C. brushless motor pump in the present invention is installed on or connected to a driving circuit of the D.C. brushless motor of a pump. The motor contains a rotor set and a stator set, while the protection circuit consists of a micro-processing unit, a driving unit, a comparison unit and a signal source. The micro-processing unit is electrically connected with a control unit, which is able to control the micro-processing unit to transmit a rotating speed control signal. The driving unit is electrically connected with the micro-processing unit for receiving the rotating speed control signal and driving the rotor set of the motor to rotate. The comparison unit preset with a rotating speed value of the rotor set is electrically connected with the micro-processing unit for changing the rotating speed control signal transmitted by the micro-processing unit. The signal source is electrically connected with the comparison unit, the signal source being a voltage signal produced by the motor itself when the rotor set is operated.

By so designing, when the rotor set is operated, the comparison unit can receive the signal source and, through logical operation, convert the signal source into a rotating speed value of the rotor set, which is then analyzed and collated with the rotating speed value preset by the comparison unit. Simultaneously, the micro-processing unit will function to supervise and control the rotating speeds of the motor to enable the motor to operate or stop operating within a range preset, thus attaining effect of protecting the structure of the D.C. brushless motor pump.

### BRIEF DESCRIPTION OF DRAWINGS

This invention will be better understood by referring to the accompanying drawings, wherein:

FIG. 1 is a block diagram of a first preferred embodiment of a protection circuit for a D.C. brushless motor pump in the present invention;

FIG. 2 is a schematic view of the first preferred embodiment of the protection circuit for D.C.

brushless motor pump in a using condition in the present invention;

FIG. 3 is a block diagram of a second preferred embodiment of a protection circuit for a D.C. brushless motor pump in the present invention; and

FIG. 4 is a schematic view of the second preferred embodiment of the protection circuit for D.C. brushless motor pump in a using condition in the present invention.

### DETAILED DESCRIPTION OF THE PREFERRED EMBODIMENT

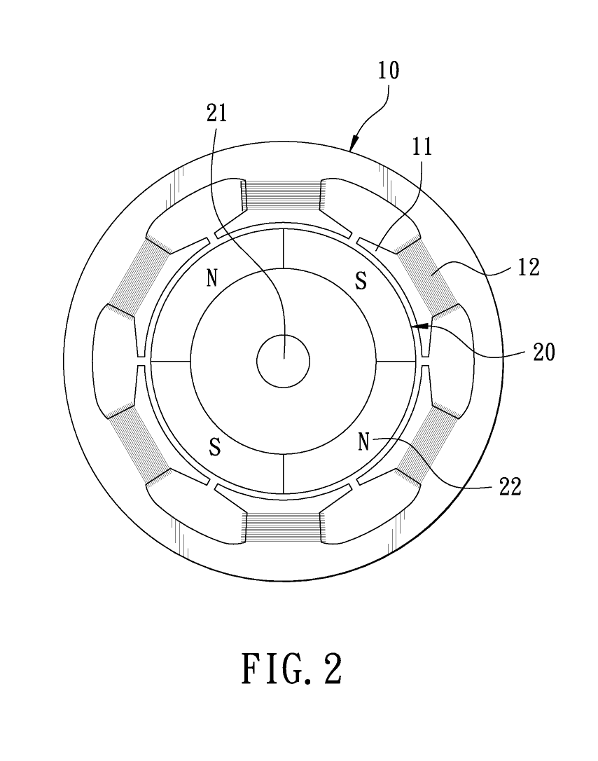

A protection circuit 30 for a D.C. brushless motor pump in the present invention is to be installed on or connected to a driving circuit 40. The driving circuit 40 is installed on a motor 100 of the D.C. brushless motor pump. The motor 100 is an inward turning three-phase D.C. brushless motor. The motor 100, as shown in FIG. 2, mainly consists of a stator set 10 and a rotor set 20. The stator set 10 is an annular body surrounding the circumferential edge of the rotor set 20 and having an annular wall of its inner circumferential edge extended toward the center to form a plurality of magnetic permeating members 11 spaced apart equidistantly and respectively having an outer peripheral edge provided with lots of coils 12. The rotor set 20 has its center fixed with a rotating shaft 21 and its circumferential edge annularly disposed with a plurality of magnetic poles or permanent magnets.

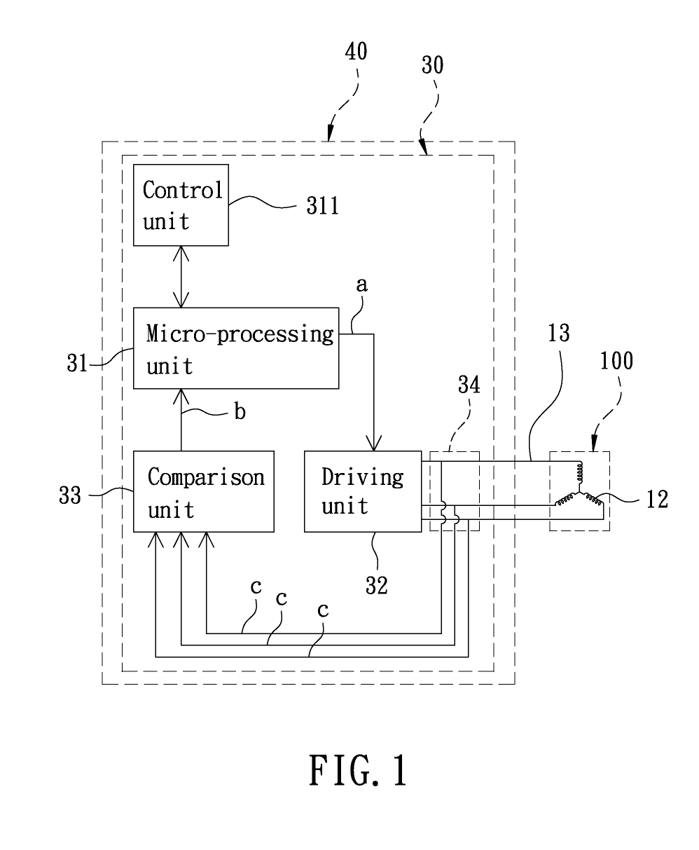

A first preferred embodiment of a protection circuit 30 for a D.C. brushless motor pump in the present invention, as shown in FIG. 1, includes a micro-processing unit 31, a driving unit 32, a comparison unit 33 and a signal source 35 as main components electrically connected together.

The micro-processing unit 31 is electrically connecting with a control unit 311 that can control the micro-processing unit 31 to transmit out a rotating speed control signal (a). In the preferred embodiment, the micro-processing unit 31 is a micro-processing IC while the control unit 311 is a micro-control module for controlling the micro-processing unit 31 to operate normally.

The driving unit 32 is electrically connected with the micro-processing unit 31 for receiving the rotating speed control signal (a) and, by means of a conductive wire set 13, transmitting direct current to the coils 12 on the magnetic permeating members 11 to make the coils 12 conduct electricity and generate magnetic fields for driving the rotor set 20 to rotate. In this preferred embodiment, the driving unit 32 is a power transistor able to decide flow quantity of D.C. to be output through change-over of the power transistor.

The comparison unit 33 electrically connected with the micro-processing unit 31 is preset with a rotating speed value (a best rotating speed value) of the rotor set 20, able to give out a feedback signal (b) to the micro-processing unit 31 for changing the rotating speed control signal (a) of the micro-processing unit 31. In this preferred embodiment, the comparison unit 33 is a comparator IC that is composed of a voltage detector and a buffer circuit.

The signal source 34 electrically connected with the comparison unit 33 is a voltage signal (c) produced by the motor 100 itself when the rotor set 20 is operated. In this preferred embodiment, the signal source 34 is a counter electromotive force picked from the conductive wire set 13 when the motor 100 is operated.

To start the motor 100 to operate, referring to FIGS. 1 and 2, the micro-processing unit 31 is started and controlled by the control unit 311 to operate and transmit a rotating speed control signal (a) to the driving unit 32 that enables the magnetic permeating members 11 of the stator set 10 to generate magnetic fields, and simultaneously the magnetic permeating members 11 will be actuated to rotate by repulsive force provided between the magnetic fields of the magnetic permeating members 11 and the permanent magnets 22 of the rotor set 20. Further, the driving unit 32 can control and convert the magnetic fields of the magnetic permeating members 11 into the same magnetic pole as that of the permanent magnets 22 of the rotor set 20 to let the rotor set 20 rotate successively in a same direction. Nevertheless, when the pump is operated, impurities or unknown objects are apt to clog the water intake of the pump and as a result, water cannot steadily flow into the pump and thus, the pump may run idle and become damaged.

Therefore, the protection circuit for a D.C. brushless motor pump in the present invention can function to supervise and control the rotating speeds of the motor 100 to judge whether or not the motor 100 is operated normally. When the rotor set 20 is rotated, the comparison unit 33 can directly obtain a voltage signal (c), which is produced during operation of the rotor set 20, from the signal source 34 (the counter electromotive force). After the voltage signal (c) is attenuated, the frequency of the voltage signal (c) is calculated to gain a rotating speed value of the rotor set 20, which is then analyzed and collated with the rotating speed value preset by the comparison unit 33. In this preferred embodiment, when the rotating speed value of the rotor set 20 is greater than the rotating speed value preset, it indicates that the rotating speed of the motor 100 is excessively high or that the motor 100 may run idle and in this case, the motor 100 and other attachments are liable to be damaged because the motor 100 is operated at high speeds for a long period of time and produces excessively high temperature. At this time, the comparison unit 34 will output the feedback signal (b) to the micro-processing unit 31 to have the micro-processing unit 31 giving out a rotating speed control signal (a) of lowering speeds to let the driving unit 32 diminish the direct current that flows through the coils 12 for lowering the rotating speeds of the rotor set 20, or the driving unit 32 can directly cut off the electricity to the coils 12 to stop the motor 100 from operating so as to prevent the motor 100 from producing excessively high temperature and causing damage. Thus, the protection circuit 30 of this invention can function to supervise and control the rotating speeds of the motor 100 to enable the motor 100 to operate at best rotating speeds or stop operating for attaining effect of protecting the structure of the pump.

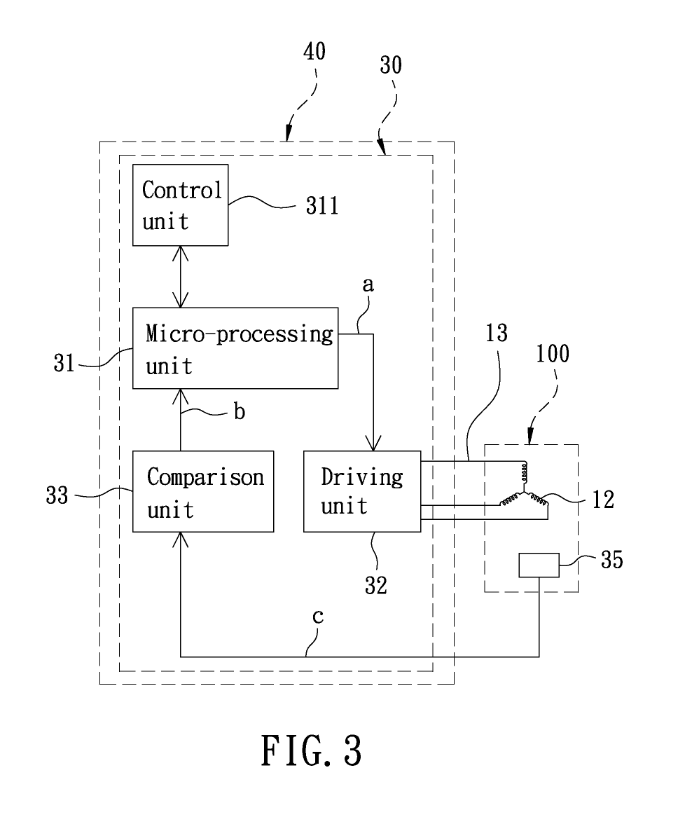

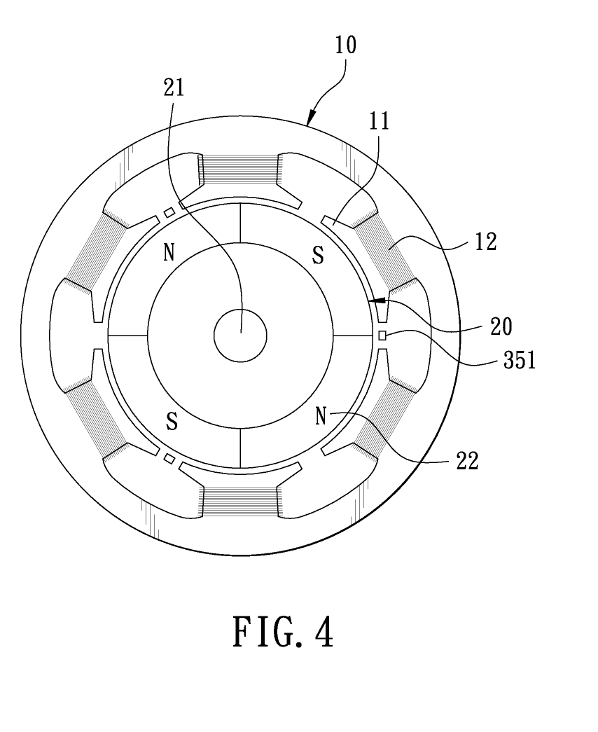

A second preferred embodiment of a protection circuit for a D.C. brushless motor pump in the present invention, as shown in FIGS. 3 and 4, has almost the same structure as that of the first preferred embodiment, except that a signal source 35 is derived from a voltage signal (c) produced by three Hall Effect ICs 351. In this preferred embodiment, the three Hall Effect ICs are spaced apart equidistantly to be respectively provided in a space of the stator set 10, used for sensing the variation of magnetic flux (field density) that passes through the Hall Effect ICs 351 when the rotor set 20 is rotated within a unit time and gaining the voltage signal (c) to be transmitted to the comparison unit 33. After logical operation, the comparison unit 33 converts the voltage signal (c) into a rotating speed value of the rotor set 20, which is then analyzed and collated with the rotating speed value preset by the comparison unit 33, and simultaneously, the micro-processing unit 31 will function to supervise and control the rotating speeds of the motor 100, equally obtaining effect of protecting the structure of the pump.

The features and the advantages of the protection circuit of this invention are described as follows.

1. Through logical operation, the comparison unit can function to convert the signal source into a rotating speed value of the rotor set, which is then analyzed and collated with the rotating speed value preset by the comparison unit, and the micro-processing unit can function to supervise and control the rotating speeds of the motor to enable the motor to operate or stop operating within a range preset, able to protect the structure of a pump.

2. In the present invention, the counter electromotive force, the Hall Effect IC or the coder can be used for detecting the rotating speeds of the motor, and it is needless to install unnecessary electronic members like a water pressure sensor or a water flow sensor, able to reduce manufacturing cost of the pump.

While the preferred embodiments of the invention have been described above, it will be recognized and understood that various modifications may be made therein and the appended claims are intended to cover all such modifications that may fall within the spirit and scope of the invention.

What is claimed is:

1. A protection circuit for a D.C. brushless motor pump being installed on or connected to a driving circuit, said driving circuit is installed on a motor of said D.C. brushless motor pump, said motor composed of a rotor set and a stator set, said protection circuit comprising:
a micro-processing unit electrically connected with a control unit, said control unit controlling said micro-processing unit to transmit a rotating speed control signal;
a driving unit electrically connected with said micro-processing unit, said driving unit receiving said rotating speed control signal and driving said rotor set of said motor to rotate;
a comparison unit electrically connected with said micro-processing unit, said comparison unit preset with a rotating speed value of said rotor set for changing said rotating speed control signal transmitted by said micro-processing unit;
a signal source electrically connected with said comparison unit, said signal source being a voltage signal produced by said motor itself when said rotor set is operated; and
said motor operated and said comparison unit receiving said signal source and carrying out logical operation, said comparison unit converting said signal source into a rotating speed value of said rotor set, which is then analyzed and collated with said rotating speed value preset, said micro-processing unit functioning to supervise and control rotating speeds of said motor for protecting the structure of said D.C. brushless motor pump.

2. A protection circuit for a D.C. brushless motor pump as claimed in claim 1, wherein said driving unit has at least one conducting wire transmitting an electric current to one of the coils of said motor to make said coil electrically conducted and generate a magnetic field for driving said motor to rotate, said signal source being a counter electromotive force picked from said conducting wire when said motor is operated.

3. A protection circuit for a D.C. brushless motor pump as claimed in claim 1, wherein said stator set of said motor is provided with at least one Hall Effect IC, and said signal source is a voltage signal produced by said Hall Effect IC, said Hall Effect IC able to detect variation of magnetic flux that passes through said Hall Effect IC and obtain said voltage signal when said rotor set is operated within a unit time.
